(19) United States
(12) Patent Application Publication
(10) Pub. No.: US 2026/0206095 A1
(43) Pub. Date: Jul. 16, 2026

(54) METHOD EXECUTED BY USER EQUIPMENT, AND USER EQUIPMENT

(71) Applicant: Sharp Kabushiki Kaisha, Sakai City, Osaka (JP)

(72) Inventors: Fangying XIAO, Shanghai (CN); Renmao LIU, Shanghai (CN)

(21) Appl. No.: 19/136,616

(22) PCT Filed: Dec. 7, 2023
(86) PCT No.: PCT/CN2023/137022

§ 371 Date: Jun. 6, 2025

(30) Foreign Application Priority Data
Dec. 9, 2022 (CN) 202211589161.X

(51) Int. Cl. H04W 76/30; H04W 76/19; H04W 76/20

(52) U.S. Cl. CPC H04W 76/30; H04W 76/19; H04W 76/20

(57) ABSTRACT

The present disclosure provides a method executed by a user equipment, and a user equipment. The method executed by the user equipment (UE) includes: receiving, by the UE, a radio resource control release (RRCRelease) message from a base station; and in the case where a suspendConfig field is included in the RRCRelease message and sdt-Config is configured, executing, by the UE, any one of the following operations: operation 1-1: re-establishing radio link control (RLC) entities associated with other RLC bearers that are not suspended except RLC entities associated with broadcast MBS radio bearers (MRBs); and operation 1-2: re-establishing RLC entities associated to RLC bearers that are not suspended of a data radio bearer (DRB) and PTP RLC entities associated to RLC bearers that are not suspended of multicast MRBs.

### TECHNICAL FIELD

The present invention relates to the technical field of wireless communications. More specifically, the present invention relates to a method executed by a user equipment, and a user equipment.

### BACKGROUND ART

A study item (SI) on architectural enhancements for 5G multicast-broadcast services (see SP-190625 for details) has been approved. One objective (referred to as Objective A) of this SI is to support general-purpose MBS services in 5GS, and use cases that can benefit from these characteristics include (but are not limited to) public safety, V2X applications, transparent IPv4/IPv6 multicast delivery, IPTV, wireless software delivery, group communications, Internet of Things applications, etc. Correspondingly, at the 3rd Generation Partnership Project (3GPP) RAN #86 plenary meeting, an NR multicast and broadcast service (NR MBS) work item was proposed (see Non-Patent Document: RP-193248: New WID: NR Multicast and Broadcast Service) and approved. This work item aims to provide the support in the RAN for Objective A. The objective of the work item has substantially been achieved. For a detailed description of related solutions, see technical documents of 3GPP Release 17, such as TS38.300-h20, TS38.331-h20, TS38.321-h20, etc.

At the 3GPP RAN #94 plenary meeting, a work item named enhanced NR multicast/broadcast (see Non-Patent Document: RP-213568: New WID: Enhancements of NR Multicast and Broadcast Services) was approved. This work item aims to further enhance the MBS multicast/broadcast of Release 17, one of the objectives of which is to support the user equipment to receive the MBS multicast service in an RRC inactive state.

At the 3GPPRAN #86 plenary meeting, a work item on small data transmissions (SDT) in the RRC inactive state has also been proposed (see Non-Patent Document: RP-193252 New WID on NR small data transmissions in INACTIVE state) and approved. This work item is intended to support infrequent transmission of small data in the RRC inactive state for UEs in the RRC inactive state. The objective of the work item has substantially been achieved. For a detailed description of related solutions, see related technical documents of 3GPP Release 17, such as TS38.300-h20, TS38.331-h20, TS38.321-h20, etc.

The present invention discusses related issues involved when a UE supporting or performing a broadcast/multicast service receives a configuration for enabling small data transmission.

### SUMMARY OF THE INVENTION

A purpose of the present invention is to provide a method executed by a user equipment (UE), and a user equipment, which can prevent data loss of an MBS broadcast service or an MBS multicast service.

According to a first aspect of the present disclosure, provided is a method executed by a user equipment (UE), comprising: receiving, by the UE, a radio resource control release (RRCRelease) message from a base station; and in the case where a suspendConfig field is included in the RRCRelease message and sdt-Config is configured, executing, by the UE, any one of the following operations: operation 1-1: re-establishing radio link control (RLC) entities associated with other RLC bearers that are not suspended except RLC entities associated with broadcast MBS radio bearers (MRBs); and operation 1-2: re-establishing RLC entities associated to RLC bearers that are not suspended of a data radio bearer (DRB) and PTP RLC entities associated to RLC bearers that are not suspended of multicast MRBs.

In the method of the first aspect described above, the suspendConfig field is used to indicate a configuration of an RRC inactive state, and the sdt-Config field is used to indicate configurations related to small data transmission (SDT).

In the method of the first aspect described above, in the case where a suspendConfig field is included in the RRCRelease message and sdt-Config is configured, the UE further executes any one of the following operations: operation 2: for each DRB in sdt-DRB-List included in the RRCRelease message, considering the DRB to be configured for SDT; and operation 3: in the case where the sdt-SRB2-Indication included in the RRCRelease message is configured, considering SRB2 to be configured for SDT.

In the method of the first aspect described above, the sdt-DRB-List field is used to indicate an identifier of a DRB configured for SDT, and the sdt-SRB2-Indication field indicates whether SRB2 is configured for SDT.

In the method of the first aspect described above, re-establishing the RLC entities comprises at least one of the following operations: discarding all RLC SDUs, RLC SDU segments, and all RLC PDUs; stopping and resetting all timers; and resetting all state variables to respective initial values thereof.

In the method of the first aspect described above, the UE is performing an MBS broadcast service or an MBS multicast service when the RRCRelease message is received.

In the method of the first aspect described above, an RRC connection resume procedure is started for SDT when all of the following conditions are met: condition 1: an upper layer requests to resume an RRC connection; condition 2: system information SIB1 comprises a common SDT configuration sdt-ConfigCommon; condition 3: all the pending data in UL is mapped to radio bearers except the MRB configured for SDT; condition 4: a lower layer indicates that a condition for starting the SDT has been met.

According to a second aspect of the present disclosure, a user equipment (UE) is provided, comprising: a processor and a memory storing instructions, wherein the instructions, when run by the processor, execute the method described herein.

### Effect of Invention

According to the method executed by the user equipment and the user equipment of the present disclosure, it is possible to prevent data loss of the MBS broadcast service or the MBS multicast service when the user equipment (UE) re-establishes an RLC entity that is not suspended.

### BRIEF DESCRIPTION OF THE DRAWINGS

The above and other features of the present invention will be more apparent from the following detailed description in combination with the accompanying drawings, in which:

(a) to (c) of FIG. 1 are schematic diagrams showing specific configurations of a radio bearer for receiving an MBS service according to the present invention.

FIG. 2 is a schematic diagram showing a basic procedure of a method executed by a user equipment according to Embodiment 1 of the present invention.

FIG. 3 is a schematic diagram showing a basic procedure of a method executed by a user equipment according to Embodiment 2 of the present invention.

FIG. 4 is a block diagram showing a user equipment according to an embodiment of the present invention.

### DETAILED DESCRIPTION OF PREFERRED EMBODIMENTS

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

The following describes some terms involved in the present invention. For the specific meanings of the terms, see the latest 3GPP related documents, for example TS38.300, TS38.321, TS38.322, TS38.323, TS38.331, etc. In addition, the embodiments of the present invention will be described by taking a broadcast/multicast service as an example, but the embodiments of the present invention are not limited to the broadcast/multicast service, and may also be applied to other application scenarios.

UE: User Equipment.

RRC: Radio Resource Control.

RRC_CONNECTED: RRC connected state.

RRC_INACTIVE: RRC inactive state.

RRC_IDLE: RRC idle state.

RAN: Radio Access Network.

NR: New RAT, New Radio Access Technology.

### MBS: Multicast/Broadcast Services.

PDCP: Packet Data Convergence Protocol.

RLC: Radio Link Control. The RLC entity may be configured to one of three modes: a transparent mode (TM), an unacknowledged mode (UM), and an acknowledged mode (AM). Corresponding RLC entities are referred to as a TM RLC entity, a UM RLC entity, and an AM RLC entity.

SDU: Service Data Unit. A data packet received by the present layer from an upper layer or submitted by the present layer to an upper layer is referred to as an SDU.

PDU: Protocol Data Unit. A data packet received by the present layer from a lower layer or submitted by the present layer to a lower layer is referred to as a PDU. For example, a PDCP data PDU is a data packet obtained after a PDCP header is added to a PDCP SDU.

SDAP: Service Data Adaptation Protocol.

RB: Radio Bearer.

DRB: Data Radio Bearer.

MRB: MBS radio bearer, i.e., a radio bearer that is configured for MBS delivery. The MRB is classified into a multicast MRB, which is a radio bearer configured for MBS multicast transmission, and a broadcast MRB, which is a radio bearer configured for MBS broadcast transmission.

TMGI: Temporary Mobile Group Identity for identifying an MBS session.

RNTI: Radio Network Temporary Identifier.

PTM: Point to Multipoint, an MBS service delivery means. In a PTM delivery means, a base station (gNB) delivers a single copy of MBS data packets to a set of UEs. The UE receives the PTM transmission using either the G-RNTI or the G-CS-RNTI. For example, the base station uses a group common physical downlink control channel (PDCCH) scrambled by a G-RNTI to schedule a group common physical downlink shared channel (PDSCH) scrambled by the same G-RNTI.

PTP: Point to Point, an MBS service delivery means. In a PTP delivery means, a RAN node (gNB) individually delivers separate copies of MBS data packets to each UEs independently. That is, the base station uses a UE-specific PDCCH scrambled by a UE-specific RNTI to schedule a UE-specific PDSCH scrambled by the same UE-specific RNTI.

G-RNTI: Group RNTI, used to scramble the scheduling and transmission of PTM for one or more MBS multicast services.

G-CS-RNTI: group configuration scheduling RNTI, used to scramble a semi-persistently scheduled (SPS) group common physical downlink shared channel (PDSCH) of one or more MBS multicast services and activate/deactivate the SPS group common PDSCH.

The RRC release message RRCRelease is used to command release of an RRC connection or suspension of an RRC connection. The RRCResume message is used to resume a suspended RRC connection. In the present invention, a network, a base station, and a RAN may be used interchangeably. The network may be a Long Term Evolution (LTE) network, an NR network, an enhanced Long Term Evolution (eLTE) network, or another network defined in a subsequent evolved version of the 3GPP.

Currently, THE NR MBS services include MBS broadcast (or an MBS broadcast session) and MBS multicast (or an MBS multicast session). The MBS broadcast provides a downlink-only MBS transmission mode for a service with low quality of service (QoS), so that a UE in an RRC connected state, an RRC idle state, or an RRC inactive state can receive the MBS service, and the UE receives an MBS configuration of the MBS broadcast by means of a broadcast control channel (MCCH). In Release 17, MBS multicast requires that a UE sets up an RRC connection to a base station, and then the base station performs configuration for the UE by means of dedicated RRC signaling (also referred to as an RRC message, for example, an RRC reconfiguration message). Radio bearers (MRBs) for receiving these MBS services (or MBS multicast sessions) may also be configured for the UE by the base station by means of dedicated RRC signaling. Only a UE that is in the RRC connected state and is configured with the MRB can receive a corresponding MBS service.

(a) to (c) of FIG. 1 are schematic diagrams showing specific configurations of a radio bearer for receiving an MBS multicast session in an RRC connected state. The radio bearer may be an MRB configured with only PTM transmission (as shown in (a) of FIG. 1), or a split MRB configured with both PTM and PTP (as shown in (b) of FIG. 1), or an MRB configured with only PTP transmission (as shown in (c) of FIG. 1). It should be noted that (a) to (c) of FIG. 1 show only a PDCP entity and an RLC entity(s) associated with a bearer and a relationship therebetween. In a downlink direction, a PDCPPDU encapsulated by the PDCP entity is submitted to the RLC entity. A UE in an RRC inactive state receives an MBS multicast service only in the PTM transmission mode. It may therefore be specified that a base station does not configure, for the UE in the RRC inactive state, an MRB using or including PTP transmission or a split MRB, or that the UE does not use (i.e. suspends) PTP transmission for receiving the MBS multicast service in the RRC inactive state, or that the base station only configures PTM transmission for an MRB received by the UE in the RRC inactive state.

The RRC release message RRCRelease is used to command release of an RRC connection or suspension of an RRC connection. The RRC resume request RRCResumeRequest or RRCResumeRequest1 message is used to request to resume a suspended RRC connection or to execute RAN-based notification area (RNA) updating. The main difference between the RRCResumeRequest and RRCResumeRequest1 messages is different UE identifiers used.

The RLC bearer includes at least an RLC entity and a logical channel, and re-establishing the RLC entity in the present disclosure refers to re-establishing an RLC entity associated with the RLC bearer.

In 3GPP Release 17, UEs in an RRC connected state, an RRC inactive state, and an RRC idle state may all receive an MBS broadcast service, and only UEs in the RRC connected state may receive an MBS multicast service. In 3GPP Release 18, it will be supported that a UE receives the MBS multicast service in the RRC inactive state.

Both the UE in the RRC connected state and the UE in the RRC inactive state may receive the RRCRelease message from a base station when the UE requests to resume the RRC connection (for example, the UE in the RRC inactive state sends an RRCResumeRequest or RRCResumeRequest1 message for an SDT).

When the UE receives the RRCRelease message from the base station, the RLC entity will be re-established for each RLC bearer that is not suspended if a suspendConfig field is included in the message and sdt-Config is configured. One of the purposes of the UE re-establishing the RLC entity is to prevent the triggering of the SDT from being affected due to the presence of old data for RLC bearers that are not used for small data transmission. If the UE does not clear data of all RLC bearers, even if all newly arrived uplink data is for a bearer configured as an SDT, the SDT will be prevented from being triggered because old data exists in an RLC bearer associated with a bearer not configured with the SDT (for example, old data exists in a buffer of a corresponding RLC entity). The operation of re-establishing the RLC entity includes discarding all RLC SDUs, RLC SDU fragments, and all RLC PDUs.

Specifically, re-establishing the RLC entity includes at least the following operations:
1. discarding all RLC SDUs, RLC SDU segments, and RLC PDUs (a corresponding operation is executed only when there is an RLC SDU, an RLC SDU segment, or an RLC PDU);
2. stopping and resetting all timers; and
3. resetting all state variables to respective initial values thereof.

When the UE receives the RRCRelease message including the suspendConfig field and the sdt-Config field, the UE will re-establish all RLC entities that are not suspended. At this time, if the UE is performing an MBS broadcast service or an MBS multicast service, an MRB (or its corresponding RLC bearer) for receiving the MBS broadcast service or the MBS multicast service is also not suspended, so that the RLC entity associated to the MRB or associated with the MRB is also re-established, which will result in data loss of the MBS broadcast service or the MBS multicast service.

Although the present disclosure proposes the following embodiments in order to solve the problems in the prior art described above, the following embodiments are merely illustrative and do not limit the scope of the present invention.

### Embodiment 1

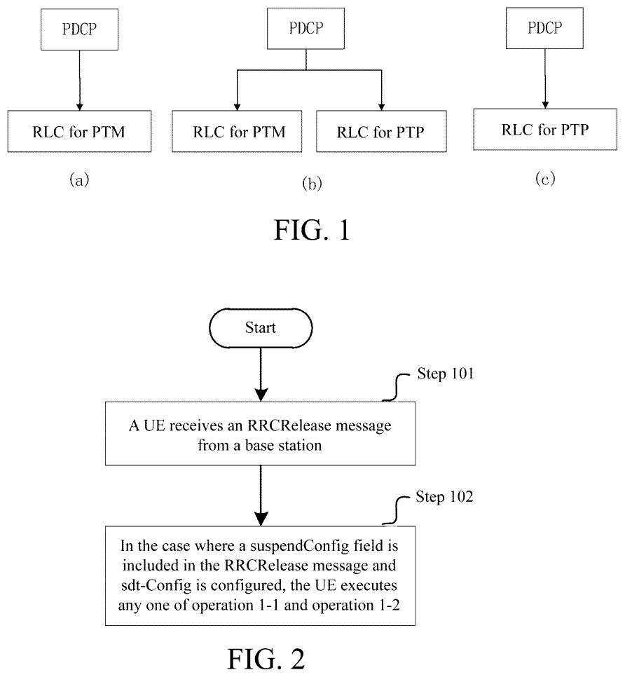

Embodiment 1 of the present disclosure will be described in detail below with reference to the accompanying drawings. FIG. 2 is a schematic diagram showing a basic procedure of a method executed by a user equipment according to Embodiment 1 of the present disclosure. As shown in FIG. 2, the method executed by the user equipment in Embodiment 1 may generally include the following steps:

Step 101: The UE receives an RRCRelease message from a base station.

Step 102: In the case where a suspendConfig field is included in the RRCRelease message and sdt-Config is configured (that is, the RRCRelease message further includes an sdt-Config field), the UE executes any one of the following operations:
operation 1-1: re-establishing RLC entities associated with other RLC bearers that are not suspended except RLC entities associated with broadcast MRBs; and
operation 1-2: re-establishing RLC entities associated to RLC bearers that are not suspended of the data radio bearers (DRB) and PTP RLC entities associated to RLC bearers that are not suspended of multicast MRBs.

That is, in Embodiment 1 described above, upon receiving the RRCRelease message including the suspendConfig field and configured with sdt-Config, the UE re-establishes the RLC entities associated with other RLC bearers that are not suspended except the RLC entities associated with the MRBs, or re-establishes only the RLC entities associated to the RLC bearers that are not suspended of the DRBs.

### Embodiment 2

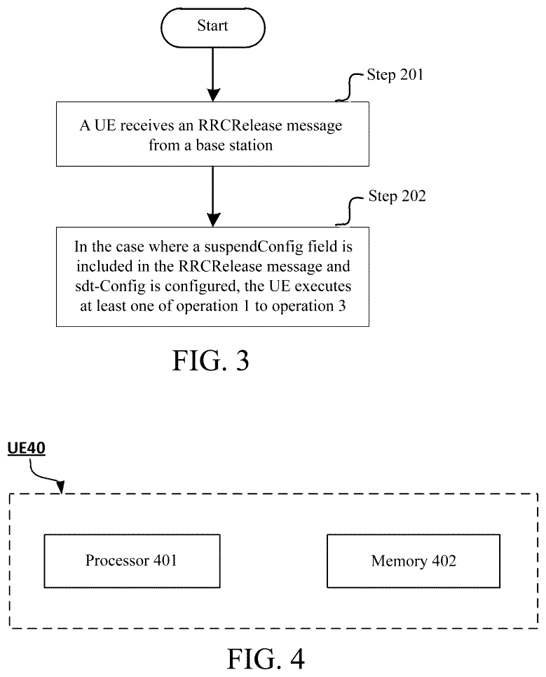

Embodiment 2 of the present disclosure will be described in detail below with reference to the accompanying drawings. FIG. 3 is a schematic diagram showing a basic procedure of a method executed by a user equipment according to Embodiment 2 of the present disclosure. As shown in FIG. 3, the method executed by the user equipment in Embodiment 3 may generally include the following steps:

Step 201: The UE receives an RRCRelease message from a base station.

Step 202: In the case where a suspendConfig field is included in the RRCRelease message and sdt-Config is configured (that is, the RRCRelease message further includes an sdt-Config field), the UE executes at least one of the following operations:
operation 1: for each DRB in sdt-DRB-List (the RRCRelease message includes the sdt-DRB-List), considering the DRB to be configured for SDT);
operation 2: if sdt-SRB2-Indication is configured (the RRCRelease message includes the sdt-SRB2-Indication), considering the SRB2 to be configured for SDT; and
operation 3: for each RLC bearer that is not suspended (except the RLC bearer associated with the MRB), re-establishing an RLC entity (i.e., re-establishing the RLC entity associated with the RLC bearer). In other words, the RLC entities associated with other RLC bearers that are not suspended except the RLC entities associated with the MRBs are re-established.

It should be noted that embodiments achieved by changing the execution order of the above operations also fall within the scope of protection of the present disclosure.

### [Variation of Embodiment 2]

As a variation of Embodiment 2, operation 3 in Embodiment 2 may be replaced with any one of the following operations:
operation 3-1: for each RLC bearer that is not suspended, re-establishing an RLC entity (except RLC entities associated to MRBs);
operation 3-2: for each RLC bearer that is not associated to an MRB and is not suspended, re-establishing an RLC entity;
operation 3-3: for each RLC bearer that is not suspended that is associated to a DRB, re-establishing an RLC entity;
operation 3-4: for each RLC bearer that is associated to a DRB and is not suspended, re-establishing an RLC entity;
operation 3-5: for each RLC bearer that is not suspended, re-establishing an RLC entity (except RLC entities associated to broadcast MRBs); in other words, re-establishing RLC entities associated with other RLC bearers that are not suspended except the RLC entities associated to the broadcast MRBs;
operation 3-6: for each RLC bearer that is not associated to a broadcast MRB and is not suspended, re-establishing an RLC entity;
operation 3-7: for each RLC bearer (except RLC entities associated to broadcast MRBs and/or multicast MRBs) that is not suspended, re-establishing an RLC entity; in other words, re-establishing RLC entities associated with other RLC bearers that are not suspended except the RLC entities associated with the broadcast MRBs and/or the multicast MRBs;
operation 3-8: for each RLC bearer that is not associated to a broadcast MRB and/or a multicast MRB and is not suspended, re-establishing an RLC entity;
operation 3-9: for each RLC bearer that is not suspended, re-establishing an RLC entity (except RLC entities associated to broadcast MRBs and/or multicast MRBs configured to be received in an RRC inactive state);
operation 3-10: for each RLC bearer that is not associated to a broadcast MRB and/or a multicast MRB configured to be received in an RRC inactive state and is not suspended, re-establishing an RLC entity; in other words, re-establishing RLC entities associated with other RLC bearers that are not suspended except the RLC entities associated to the broadcast MRBs and/or the multicast MRBs configured to be received in the RRC inactive state;
operation 3-11: for each RLC bearer that is not suspended for a non-PTM transmission (that is, it is not used for a PTM transmission), re-establishing an RLC entity; in other words, re-establishing RLC entities for all RLC bearers that are not suspended and are not used for PTM transmissions;
operation 3-12: for each RLC bearer that is not suspended, re-establishing an RLC entity (except an PTM RLC entity); in other words, re-establishing RLC entities associated with other RLC bearers that are not suspended except the PTM RLC entity, namely, not re-establishing the PTM RLC entity even if the RLC bearer associated with the PTM RLC entity is not suspended.
operation 3-13: for each RLC bearer that is not suspended and is associated to a DRB or to a multicast MRB, re-establishing the RLC entity associated to the DRB and the PTM RLC entity associated to the multicast MRB, wherein optionally, it may be further specified that re-establishment is performed only when the PTP RLC entity of the multicast MRB is an AM RLC entity; and
operation 3-14: for each RLC bearer that is not suspended and is associated to a DRB or each PTP RLC bearer that is not suspended and is associated to a multicast MRB, re-establishing the RLC entity associated to the DRB and the PTM RLC entity associated to the multicast MRB, wherein optionally, it may be further specified that re-establishment is performed only when the PTP RLC entity of the multicast MRB is an AM RLC entity.

In the above operations, the PTM RLC entity includes an RLC entity associated to the broadcast MRB and a PTM RLC entity associated to the multicast MRB, unless otherwise specified.

It should be noted that, in the present disclosure, the suspendConfig field is used to indicate the configuration of the RRC inactive state; the sdt-Config field is used to indicate a SDT-related configuration; and the sdt-DRB-List field is used to indicate an identifier of a DRB configured for SDT, and if the size of the field is 0, it means that the UE assumes that no DRB is configured for SDT. The sdt-SRB2-Indication field indicates whether SRB2 is configured for SDT or not.

An example of an inclusion relationship between various fields is given below, and for the description of the fields not defined in the present disclosure, see TS38.331-h20:

RRCRelease message

| | |
|---|---|
| -- ASN1START | |
| -- TAG-RRCRELEASE-START | |
| RRCRelease ::= | SEQUENCE { |
| rrc-TransactionIdentifier | RRC-TransactionIdentifier, |
| criticalExtensions | CHOICE { |
| rrcRelease | RRCRelease-IEs, |
| criticalExtensionsFuture | SEQUENCE { } |
| } | |
| } | |
| RRCRelease-IEs ::= | SEQUENCE { |
| redirectedCarrierInfo | RedirectedCarrierInfo |
| OPTIONAL, -- Need N | |
| cellReselectionPriorities | CellReselectionPriorities |
| OPTIONAL, -- Need R | |
| suspendConfig | SuspendConfig |
| OPTIONAL, -- Need R | |
| deprioritisationReq | SEQUENCE { |
| deprioritisationType | ENUMERATED [symbol] frequency, nr [symbol] , |
| deprioritisationTimer | ENUMERATED [symbol] min5, min10, min5, min30 [symbol] |
| } | |
| OPTIONAL, -- Need N | |
| lateNonCriticalExtension | OCTET STRING |
| OPTIONAL, | |
| nonCriticalExtension | [symbol] |
| OPTIONAL | |
| } | |
| [symbol] Irrelevant parts have been hidden [symbol] | |
| SuspendConfig ::= | SEQUENCE { |
| [symbol] | [symbol] |
| [symbol] | [symbol] |
| ran-PagingCyle | PagingCycle, |
| ran-NotificationAreaInfo | RAN-NotificationAreaInfo |
| OPTIONAL, -- Need M | |
| t380 | PeriodicRNAU-TimerValue |
| OPTIONAL, -- Need R | |
| nextHopChainingCount | NextHopChainingCount, |
| ..., | |
| [symbol] | |
| [symbol] | RNTI-Value |
| OPTIONAL, -- Cond [symbol] | |
| sdt-Config-r17 | SetupRelease { SDT-Config-r17 } |
| OPTIONAL, -- Need M | |
| [symbol] | SetupRelease [symbol] |
| OPTIONAL, -- Need M | |
| [symbol] | ExtendedPagingCycle-r17 |
| OPTIONAL -- Cond RANPaging | |
| [symbol] | |
| [symbol] | |
| [symbol] Irrelevant parts have been hidden [symbol] | |
| SDT-Config-r17 ::= | SEQUENCE { |
| sdt-DRB-List-r17 | SEQUENCE (SIZE (0..maxDRB)) OF DRB-Identity |
| OPTIONAL, -- Need M | |
| sdt-SRB2-Indication-r17 | ENUMERATED {allowed} |
| OPTIONAL, -- Need R | |
| [symbol] | SetupRelease [symbol] |
| OPTIONAL, -- Need M | |
| [symbol] dt-DRB-ContinueROHC-r17 | ENUMERATED [symbol] |
| OPTIONAL, -- Need S | |
| } | |
| [symbol] Irrelevant parts have been hidden [symbol] | |
| -- TAG-RRCRELEASE-STOP | |
| -- ASN1STOP | |

[symbol]

indicates data missing or illegible when filed

When the UE determines whether to start the RRC resume procedure for the SDT purpose, the UE determines whether all the pending data in UL is mapped to radio bearers configured for SDT. If there is pending data in UL that is mapped to a radio bearer that is not configured for SDT, the UE does not start the RRC resume procedure for the SDT purpose, that is, when the UE executes the RRC resume procedure, a random access resource or a configuration grant resource configured specifically for starting the RRC resume procedure for the SDT purpose is not used. If the RRCRelease message including the suspendConfig field and the sdt-Config field is received by the UE, the UE re-establishes all RLC entities that are not suspended except the RLC entities associated to the MRBs. If the UE is configured with a multicast MRB and the multicast MRB is associated with a PTP RLC (or an AM RLC entity or a PTP AM RLC entity), since the receiving end of the AM RLC entity may generate a status report (i.e., a status PDU) after receiving an RLC PDU from its opposite entity, the status report is used by the receiving end of the AM RLC entity to notify the opposite AM RLC entity that it has successfully received RLC data PDU and that the receiving end of the AM RLC entity has detected missing RLC data PDU. The status report may be stored in a buffer of the AM RLC entity as pending data in UL. After the UE enters the RRC inactive state, the data in the buffer of the AM RLC entity will be reserved since the UE does not re-establish the RLC entity associated to the MRB. If pending data in UL that is mapped to a radio bearer configured for SDT arrives, this will prevent the UE from starting the RRC connection resume procedure for SDT since pending data in UL (e.g. status PDU) also exists in the AM RLC entity associated to the multicast MRB. The following provides embodiments to solve the problem.

### Embodiment 3

Embodiment 3 of the present disclosure will be described in detail below. In Embodiment 3, when determining whether to start the RRC resume request process for the SDT purpose, the UE determines whether all the pending data in UL is from bearers configured for the SDT purpose, without considering uplink data mapped to an MRB bearer (or a multicast MRB bearer).

Specifically, the UE in the RRC inactive state starts a resume procedure or an RRC connection resume procedure for SDT when all the following conditions are met:

Condition 1: An upper layer (e.g., non-access stratum (NAS) layer) requests to resume an RRC connection.

Condition 2: SIB1 includes sdt-ConfigCommon. The system information SIB1 includes relevant information evaluating whether the UE is allowed to access a cell and defines the scheduling of other system information. It also includes radio resource configuration information that is common to all UEs and restriction information that applies grant access control. The field sdt-ConfigCommon includes a common SDT configuration including an sdt-RSRP-Threshold field, an sdt-LogicalChannelSR-DelayTimer field, an sdt-Data VolumeThreshold field, and a t319a field. The dt-RSRP-Threshold field indicates an RSRP threshold used to determine whether to start the SDT process, the sdt-LogicalChannelSR-DelayTimer field and the sdt-Data VolumeThreshold indicate a data volume threshold used to determine whether to start the SDT process, and the t319a field is used to indicate an initial value of timer T319a. The more specific meaning and use of these fields are explicitly described in TS38.331 and TS38.321.

Condition 3: sdt-Config is configured.

Condition 4: All the pending data in UL (excluding the pending data in UL mapped to the MRB) is mapped to the radio bearers configured for SDT, that is, all the pending data in UL except the pending data in UL mapped to the MRB is mapped to the radio bearers configured for SDT. In other words, if there is pending data in UL mapped to the radio bearer configured for SDT and all the other pending data in UL (if any) is mapped to the MRB, it is considered that condition 4 is met.

Condition 5: A lower layer (e.g., media access control (MAC) layer) indicates that the condition for starting SDT has been met.

### [Variation of Embodiment 3]

As a variation of Embodiment 3, condition 4 in Embodiment 3 may be replaced with any one of the following conditions:

Condition 4-1: All the pending data in UL is mapped to the radio bearers (excluding the multicast MRB) configured for SDT, that is, all the other pending data in UL except the pending data in UL mapped to the multicast MRB is mapped to the radio bearers configured for SDT. In other words, if there is pending data in UL mapped to the radio bearer configured for SDT and other pending data in UL (if any) is mapped only to the multicast MRB, it is considered that condition 4-1 is met.

Condition 4-2: All the pending data in UL is mapped to the radio bearers (excluding the multicast MRB configured with PTP transmission) configured for SDT, that is, except for the pending data in UL mapped to the multicast MRB configured with the PTP transmission, all the other pending data in UL is mapped to the radio bearers configured for SDT. In other words, if there is pending data in UL mapped to a radio bearer configured for SDT and all the other pending data in UL (if any) is mapped to a multicast MRB configured with PTP transmission, it is considered that condition 4-2 is met.

Condition 4-3: All the pending data in UL is mapped to the radio bearers (excluding the multicast MRB configured or associated with the AM RLC bearer or entity) configured for SDT, that is, all the other pending data in UL, except the pending data in UL mapped to the multicast MRB configured or associated with the AM RLC bearer, is mapped to the radio bearers configured for SDT. In other words, if there is pending data in UL mapped to a radio bearer configured for SDT and all other pending data in UL (if any) is mapped to a multicast MRB configured or associated with an AM RLC bearer or entity, condition 4-3 is met.

Condition 4-4: All the pending data in UL is mapped to the radio bearers (excluding the AM RLC bearer associated with the multicast MRB) configured for SDT, that is, all the other pending data in UL, except the pending data in UL mapped to the AM RLC bearer associated with the multicast MRB, is mapped to the radio bearers configured for SDT. In other words, if there is pending data in UL mapped to a radio bearer configured for SDT and all other pending data in UL (if any) is mapped to a multicast MRB configured or associated with an AM RLC bearer or entity, condition 4-3 is met.

### Embodiment 4

In this example, a user equipment (UE) according to the present disclosure is described. FIG. 4 shows a block diagram of a user equipment (UE) according to the present invention. As shown in FIG. 4, the user equipment (UE) 40 includes a processor 401 and a memory 402. The processor 401 may include, for example, a microprocessor, a microcontroller, an embedded processor, etc. The memory 402 may include, for example, a volatile memory (such as a random access memory (RAM)), a hard disk drive (HDD), a non-volatile memory (such as a flash memory), or other memories. The memory 402 has program instructions stored thereon. When run by the processor 401, the instructions can execute various methods such as the above-mentioned mobile information reporting method described in detail in the present invention.

Additionally, the computer-executable instructions or program running on the device according to the present invention may be a program that enables the computer to implement the functions of the embodiments of the present invention by controlling the central processing unit (CPU). The program or information processed by the program may be temporarily stored in a volatile memory (for example, a random access memory (RAM)), a hard disk drive (HDD), a non-volatile memory (for example, a flash memory), or other memory systems.

The computer-executable instructions or program for implementing the functions of the embodiments of the present invention may be recorded on a computer-readable storage medium. The corresponding functions may be achieved by reading programs recorded on the recording medium and executing the programs by a computer system. The phrase “computer system” herein may be a computer system embedded in the device, which may include operating systems or hardware (e.g., peripherals). The “computer-readable storage medium” may be a semiconductor recording medium, an optical recording medium, a magnetic recording medium, a short-time dynamic memory program recording medium, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application-specific integrated circuits (ASICs), field-programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulting from appropriate combination of the technical means disclosed in the different embodiments are also included within the technical scope of the present invention. In addition, components with the same effect described in the above embodiments may be replaced with one another.

1-8. (canceled)

9. A user equipment (UE), comprising:
a processor; and
a memory in electronic communication with the processor, wherein instructions stored in the memory are executable to:
receive a radio resource control release (RRCRelease) message; and
when sdt-Config is configured in the RRCRelease message,
re-establish a radio link control (RLC) entity for each of RLC bearers except RLC bearers associated with first multicast/broadcast service (MBS) radio bearers (MRBs), the each of RLC bearers not being suspended, and the first MRBs including broadcast MRBs, wherein
the sdt-Config is used to indicate configurations for small data transmission.

10. The UE according to claim 9, wherein
the first MRBs further include multicast MRBs.

11. A base station communicating with a user equipment (UE), comprising:
a processor; and
a memory in electronic communication with the processor, wherein instructions stored in the memory are executable to:
transmit a radio resource control release (RRCRelease) message, wherein
when sdt-Config is configured in the RRCRelease message, the UE re-establishes a radio link control (RLC) entity for each of RLC bearers except RLC bearers associated with first multicast/broadcast service (MBS) radio bearers (MRBs), the each of RLC bearers are not suspended, and the first MRBs include broadcast MRBs, and
the sdt-Config is used to indicate configurations for small data transmission.

12. The base station according to claim 11, wherein
the first MRBs further include multicast MRBs.

13. A control method in a user equipment (UE), comprising:
receiving a radio resource control release (RRCRelease) message; and
when sdt-Config is configured in the RRCRelease message,
re-establishing a radio link control (RLC) entity for each of RLC bearers except RLC bearers associated with first multicast/broadcast service (MBS) radio bearers (MRBs), the each of RLC bearers not being suspended, the first MRBs including broadcast MRBs, wherein
the sdt-Config is used to indicate configurations for small data transmission.
